(19) United States
(12) Patent Application Publication
(10) Pub. No.: US 2023/0217892 A1
(43) Pub. Date: Jul. 13, 2023

(54) SIDECAR PET SEAT

(71) Applicant: Grand Canyon Homes, LLC, Scottsdale, AZ (US)

(72) Inventors: Mary A Stringer, Scottsdale, AZ (US); Konstantin Dolgan, Bossier City, LA (US)

(21) Appl. No.: 17/647,460

(22) Filed: Jan. 9, 2022

(51) Int. Cl. A01K 1/02; A01K 1/035

(52) U.S. Cl. CPC A01K 1/0254; A01K 1/0353

(57) ABSTRACT

A pet seat system, apparatus, and method for attaching to a chair. A pet sidecar apparatus is disclosed that includes a basket, a platform configured to support the basket, and one or more straps configured to attach the pet sidecar apparatus to the side of a chair. The pet sidecar apparatus provides a comfortable area for a pet to sit while at the level of the human user. The pet sidecar apparatus moves with a rollable desk chair and does not impede the motion of the desk chair while the human user is able to sit in the desk chair. The pet sidecar apparatus has an easily cleanable universal design that can fit a variety of desk chairs and is safe for both the pet and the human user.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of pet bedding. More particularly, the present disclosure relates to a pet bed that attached to human furniture.

### DESCRIPTION OF RELATED TECHNOLOGY

Pets in the office and home office environment are shown to improve morale, improve communication and relationships between coworkers, reduce stress, increase productivity, increase team cohesion and camaraderie, and improve employee recruiting and retention. As businesses realize these benefits and as more workers are working from home, offices both in the home and away from home, need furniture to accommodate these furry team members.

Around the mid-nineteenth century, as more workers spent their shifts sitting at a desk, desk chairs (also known as office chairs) were developed leading to the adoption of several features not found on other chairs. Desk chairs are types of chairs that may include a set of wheels for mobility and have an adjustable height. Modern desk chairs frequently use a single load bearing leg positioned under the chair seat. Near the floor the leg spreads out to several smaller feet which are often wheeled (casters).

Ergonomic design and user comfort has become increasingly important as workers are spending more than a few hours seated. The seat may include a backing with a headrest for head support, back and lumbar supports, and armrests, including adjustable armrests, that allow a user to comfortably position their bodies to prevent repetitive stress injuries and back pain associated with sitting for long periods.

### BRIEF DESCRIPTION OF THE DRAWINGS

FIG. 1 illustrates an exemplary pet sidecar attached to a desk chair useful in explaining various aspects of the present disclosure.

FIG. 2A illustrates an orthogonal attachment side view of an exemplary pet sidecar useful in illustrating the attachment mechanism to a desk chair.

FIG. 2B illustrates an orthogonal view of an opposing-attachment side view of an exemplary pet sidecar.

FIG. 3 illustrates a perspective view of the platform of an exemplary pet sidecar without the attachable basket.

FIG. 4 illustrates an orthogonal view of an underside of the base of the platform of an exemplary pet sidecar with a cutaway portion of the padding arm housing to illustrate the adjustable padding arms and the padding arm index holes.

FIG. 5 illustrates a perspective view of an exemplary pet sidecar with a cutaway portion of the padding arm housing and the adjustment arm housing.

FIG. 6 illustrates an orthogonal front view of an exemplary pet sidecar (relative to the forward-facing side of a desk chair and forward when attached) useful in illustrating aspects of the present disclosure.

FIG. 7 is a perspective view of an exemplary pet sidecar illustrating an interior cavity and interior structure of the basket.

Additional exemplary views of a pet sidecar are found in the APPENDIX.

### DETAILED DESCRIPTION

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

### Existing Solutions

Workplaces looking to provide a comfortable seating area for office pets have turned to traditional pet beds that sit on the ground and provide an area for a pet to lounge. Pet hammocks may be used to provide some lift off the floor. In some existing pet seats, the desk chair itself supports a basket, using the chairback of the desk chair for support. These solutions, however, do not allow concurrent use by a human to sit in the chair as it is occupied by the pet seat. Additional solutions attach a seat/hammock behind the chair of the user. However, these solutions do not allow the human to see or stroke the pet or otherwise interact with the pet when seated in the desk chair.

Further, existing desk chairs are designed to accommodate a single user and do not accommodate a pet sitting beside a user. And in cases where a pet can fit on a desk chair with a user, the pet is liable to fall out of the desk chair either in the front or around an arm on a side of the desk chair. If a pet is sitting on the lap of a user, the user may be unable to sit adjacent a desk or write or type on a keyboard on the desk while the pet is on the user's lap.

Solutions are therefore needed that provide a comfortable area for a pet to sit or lounge at the level of the human user. Further, solutions are needed that are safe for both the pet and the human user. Additionally, solutions are needed that allows the human user to be physically close to the pet without the pet needing to be in the human user's arms or lap.

Examples of the pet seat apparatus described herein are designed to compensate for the described deficiencies. In one specific aspect, the pet seat apparatus includes a platform that when installed is at seat height of the desk chair of the human user. As desk chairs comes in a variety of different designs and sizes, to ensure the platform remains at the height of the desk chair, exemplary embodiments of the present disclosure are adjustable to fit a variety of desk chairs. Further, as many desk chairs are movable (e.g., on casters), examples of the pet seat described herein moves with and does not impede the motion of the desk chair allowing the pet seat to remain attached to the desk chair during movement which means the human user can remain physically close to the pet. Examples of the pet seat apparatus include straps that connect to an arm of the desk chair, so the pet seat apparatus does not need additional supports to the ground.

### Example Operation

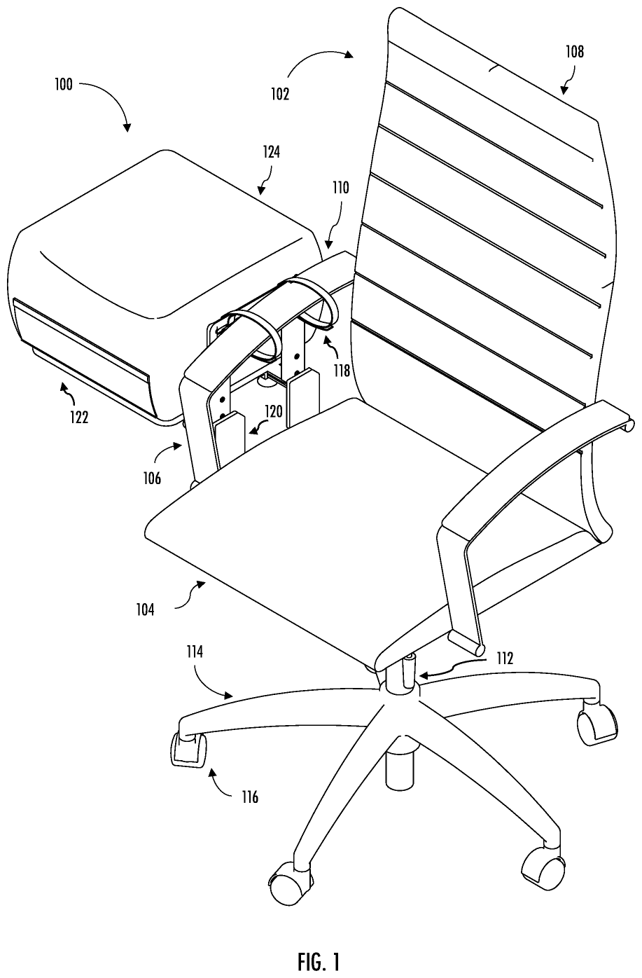

FIG. 1 illustrates pet sidecar 100 attached to desk chair 102 useful in explaining various aspects of the present disclosure.

Desk chair 102 includes seat 104, arms 106, and backrest 108. Arms 106 include armrests 110. Seat 104 sits on an extendable spindle 112 that can raise or lower seat 104 of desk chair 102. Spindle 112 may also allow desk chair 102 to swivel, with 360° of movement. Spindle 112 rests on base 114. Base 114 rests on casters 116. Base 114 may include a plurality of legs (e.g., 4 legs, 5 legs, etc.), each leg of base 114 including a caster 116. Casters 116 allow desk chair 102 to roll around allowing a user the ability to roll desk chair 102 around a space and shift desk chair 102 around, in some instances with the user seated.

In some examples, desk chair 102 is a fixed chair where base 114 is not on casters 116 and instead base 114 rests directly on the floor. In other examples, desk chair 102 has one or more legs (2 legs, 3 legs, 4 legs, 5 legs, etc.) that descend from seat 104 to the floor. The one or more legs may be attached to casters 116.

Pet sidecar 100 may attach to a variety of types of chairs. Virtually any kind of chair with stable arms and a seat may be used to attach pet sidecar 100. For example, pet sidecar 100 may be attached to a stationary chair (without, e.g., casters; with multiple legs, etc.).

Pet sidecar 100 attaches to desk chair 102 via support straps 118. When installed, the weight of pet sidecar 100 is stabilized on the arm side of seat 104 via padding plates 120. Padding plates 120 are configured to stabilize pet sidecar 100 by contacting additional parts of desk chair 102, e.g., seat 104, rather than having a single area of contact on arm 106 of desk chair 102 alone (with support straps 118.) Padding plates 120 are configured to hold pet sidecar 100 out to the side (such that the center of gravity of pet sidecar 100 is not directly beneath the support armrest) which presses pet sidecar 100 into the side of desk chair 102. Padding plates 120 may protect desk chair 102 from contact with components on the chair-facing side of pet sidecar 100 that could rub against, snag, or puncture portions of desk chair 102. The side pressure from padding plates 120 ensures that pet sidecar 100 is held firmly in place at a level position. The combined assembly of desk chair 102 and pet sidecar 100 (with the pet) has a center of gravity that may not extend beyond casters 116 and/or base 114; otherwise, desk chair 102 and pet sidecar 100 would be unbalanced and tip over. As the center of gravity of the combination of desk chair 102 and pet sidecar 100 does not extend beyond casters 116 and/or base 114 of desk chair 102, pet sidecar 100 may attach stably to desk chair 102 without the use of additional legs (or other connections to the floor). Said another way, the combined center of gravity is not in an area directly under or within the pet sidecar 100 and is within an area above the floor bounded on the sides by the legs/base 114 of desk chair 102.

Padding plates 120 prevents damage to desk chair 102 from the pressure of pet sidecar 100. Padding plates 120 can be made of any suitable padding or material that provides the stability to pet sidecar 100 and cushion to not damage/pierce/mar seat 104. In one example, padding plates 120 include foam padding glued to a metal backer plate however padding plates 120 may also include an air cushion, thick or bundled fabric, and/or gels, and a structural material such as metal and/or plastic.

The design of the attachment mechanism (support straps 118 and padding plates 120) of pet sidecar 100 is configured such that platform 122 of pet sidecar 100 remains parallel to the floor when attached to desk chair 102 to maintain stability of desk chair 102. This provides a safe and stable base for pets to sit in basket 124 of pet sidecar 100. Padding plates 120 are configured to abut seat 104 with an adjustable height as well as extend them out to correctly position the base of pet sidecar 100 parallel to the floor so support straps 118 may support the weight of and provide balance for pet sidecar 100. The extendibility of padding plates 120 allow pet sidecar 100 to attach to a variety of chairs. Padding plates 120 also provide another point of contact with desk chair 102 to provide stability to pet sidecar 100. For the purposes of illustration, support straps 118 are illustrated as loosely binding arm 106 of desk chair 102. In operation, support straps 118 should be tightly bound to arm 106 so support straps 118 do not shift on arm 106 causing instability of pet sidecar 100.

In one embodiment, support straps 118 are hook and loop (velcro) straps. This allows for ease of installation and removal. Support straps 118 are also secured using buckle 216. Buckle 216 is permanently attached to (e.g., sewn into) an end of support strap 118. In an alternative embodiment, buckle 216 is removably connected to support strap 118 and uses friction to remain in place.

In other embodiments, support straps 118 may include ties (e.g., cable ties), straps (e.g., leather, nylon, or polypropylene webbing), or cables (e.g., coated steel) and buckle 216 may include clips (cinching straps, quick/side release buckles), ratchets, and/or hooks or other attachment devices. In other embodiments, support straps 118 may include clamps (e.g., G or C clamps, vice grip, spring clamps). The clamps may tighten around arm 106 and be adjustable with screws, thumb screws, or other tightening or locking mechanism. Clamps may be padded with foam or other material so as to not damage arm 106 of desk chair 102.

In a further embodiment, support straps 118 are configured to wrap around seat 104 of desk chair 102. In another embodiment, support straps 118 are configured to be wrapped around backrest 108. In yet another embodiment, pet sidecar 100 may be supported by an under-seat mounting using e.g., a mounting plate that connects from the underside of pet sidecar 100 to the underside of seat 104 of desk chair 102. In certain variants the mounting plate is removably attachable to desk chair 102 for ease of detaching and reattaching pet sidecar 100.

The attachment mechanism (support straps 118 and padding plates 120) of pet sidecar 100 allow pet sidecar 100 to move with desk chair 102 rather than requiring an additional support to the floor (e.g., one or more legs on pet sidecar 100) or to another device (e.g., a connection to a desk or other furniture) to provide stability. Desk chair 102 with pet sidecar 100 becomes a single moveable unit rather than pet sidecar 100 as an independent seat. A user of pet sidecar 100 can roll desk chair 102 freely with pet sidecar 100 mounted, rather than having to disassemble or detach pet sidecar 100 to move or shift desk chair 102. Desk chair 102 with casters 116 may remain mobile following installation of pet sidecar 100 rather than desk chair 102 being rendered immobile.

The weight of pet sidecar 100 is applied to support straps 118 when attached to an arm 106 of desk chair 102. When secured, support straps 118 pull pet sidecar 100 tightly against desk chair 102 which produces less torque on desk chair 102 compared to, for example, a beam clamped on the arm of the seat which would act as a lever on desk chair 102 making desk chair 102 unstable. Support straps 118 cause the weight of pet sidecar 100 to pull down (rather than the side) on desk chair 102 compared to other mechanisms that do not closely bind pet sidecar 100 to desk chair 102. Due to the relative weights of desk chair 102 and pet sidecar 100, pet sidecar 100 may balance on one side of desk chair 102 without a counterweight. In another embodiment, usable with larger pets, a counterweight disposed on the non-attached arm of desk chair 102 is used to balance the torque/leverage of pet sidecar 100.

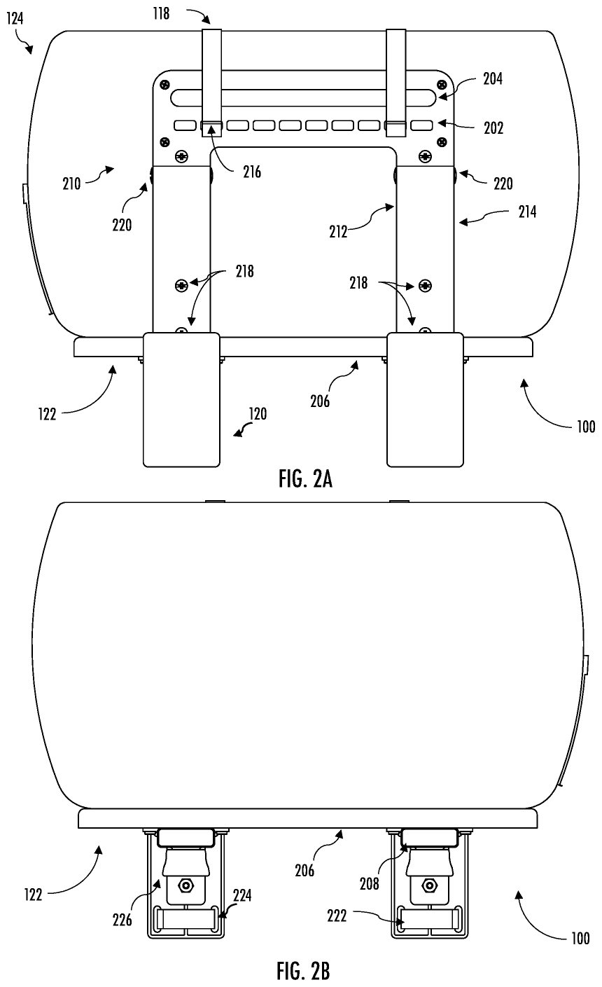

Support straps 118 are adjustable for use attaching pet sidecar 100 to a variety of types of desk chairs, like desk chair 102. FIG. 2A illustrates an orthogonal attachment side view of pet sidecar 100 useful in illustrating the attachment mechanism to desk chair 102. FIG. 2B illustrates an orthogonal view of an opposing-attachment side view of pet sidecar 100. Support straps 118 are threaded through one or more adjustment holes 202 and 204 of platform 122. Adjustment holes 202 may be sized to fit around support straps 118 snuggly such that support straps 118 cannot move laterally shifting pet sidecar 100 on desk chair 102. Different ones of adjustment holes 202 may be threaded by support straps 118 to accommodate different sized and shaped arms of various kinds of chairs.

Platform 122 includes a base 206 that supports the underside of basket 124, adjustable padding arms 208 that attaches to padding plates 120 configured to support platform 122 against seat 104 of desk chair 102, and an adjustable attachment side support 210. Attachment side support 210 includes an attachment portion with adjustment holes 202 and 204 and height adjustment arms 212. Adjustment arms 212 adjust the height of platform 122 of pet sidecar 100. Adjusting the height of platform 122 such that support straps 118 can wrap around an arm 106 of desk chair 102 while padding plates 120 can rest against seat 104 of desk chair 102. Platform 122 and base 206 may be constructed out of any suitable material that hold the weight of pet sidecar 100 and maintain the structural integrity. For example, base 206 should not flex or deform such that base 206 will not be able to maintain a substantially parallel position with respect to the floor. In one example, portions of platform 122 and base 206 are constructed out of sturdy plastics and/or metal.

Adjustment arms 212 have an adjustment arm housing 214 and a housing screw 218. Adjustment arm housing 214 of adjustment arms 212 protect and shield length adjusting components within adjustment arms 212. Housing screws 218 affix adjustment arm housing 214 to internal components and platform 122. Adjustment screws 220 allow a user to select a height (or length) setting for adjustment arms 212 and lock adjustment arms 212 into that selected position. The selection may be chosen such that padding plates 120 line up with seat 104 of desk chair 102.

Adjustable padding arms 208 may be configured to attach to padding plates 120 via padding straps 222. Padding straps 222 maybe attached directly to the back (non-padded) side of padding plates 120 and may thread into padding attachment slits 224. The removability of padding plates 120 from adjustable padding arms 208 (and pet sidecar 100) allows for ease of washing of padding plates 120.

Adjustable padding arms 208 may be adjusted to bring padding plates 120 in contact with seat 104 of desk chair 102 by extending padding plates 120 (and adjustable padding arms 208) outward or inward. Adjustable padding arms 208 may, when in an unlocked position, slide from a non-extendable to extendable positions. The non-extendable and each of the extendable positions of adjustable padding arms 208 may have an associated stop which may be locked into place for stability of pet sidecar 100. In a locked position, adjustable padding arms 208 is stationary. In some embodiments, adjustable padding arms 208 may include an undermount glide arm that fits within a rail attached to the underside (floor-side) of platform 122. In other embodiments, adjustable padding arms 208 may telescope.

Adjustment arms 212 and adjustable padding arms 208 work in concert to provide both height and width adjustment for padding plates 120 such that pet sidecar 100 can mount to a variety of chair and arm shapes. Adjustment knobs 226 are configured to be pulled away from adjustable padding arms 208, to move adjustable padding arms 208 from a locked to an unlocked state, allowing adjustable padding arms 208 to freely slide. When released, adjustment knobs 226 are configured to lock adjustable padding arms 208 into place.

In examples where adjustment knobs 226 are on the underside (towards the floor) of platform 122 during intended operation, locking pins alone (without adjustment knobs 226 attached to platform 122) may fall out due to gravity and through movement of pet sidecar 100. Adjustment knobs 226 that remain attached to platform 122 may thus be configured to remain coupled to platform 122 in both a locked and an unlocked state.

Adjustment knobs 226 may include a locking pin that when adjustment knobs 226 is pulled away from adjustable padding arms 208 is pulled out of padding arm index holes in adjustable padding arms 208. Adjustment knobs 226 maybe spring loaded such that when released will push the locking pin into a padding arm index hole to lock adjustable padding arms 208. As illustrated, adjustable padding arms 208 may each move (and be adjusted) independently so that each adjustable padding arm 208 can abut seat 104 regardless of its shape (e.g., if one portion of seat 104 bulges more than another). In another example, adjustable padding arms 208 may move or be adjusted only in tandem.

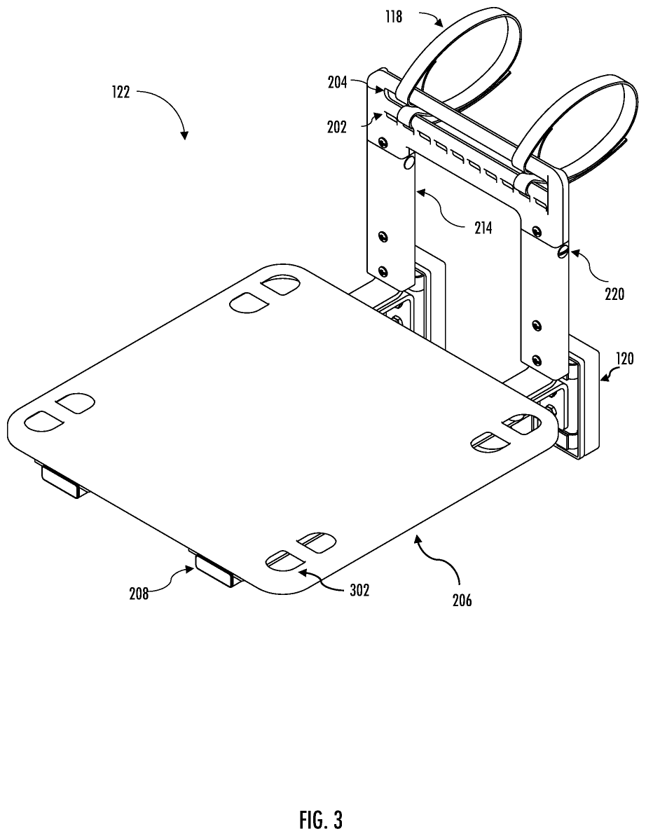

FIG. 3 illustrates a perspective view of platform 122 of pet sidecar 100 without the attachable basket 124. Support straps 118 are illustrated threading through adjustment holes 202 and 204.

Base 206 of platform 122 is configured to support and secure basket 124. Base attachment holes 302 are configured for straps affixed or tied to basket 124 threaded through base attachment holes 302. While four pairs of attachment holes 302 are illustrated in FIG. 3, as can be appreciated by those of ordinary skill, a greater or fewer number of pairs of base attachment holes 302 may be used with similar effect. For example, a fifth pair of base attachment holes 302 may be punched out of base 206 (e.g., in the center of base 206). In another example, two or three pairs of base attachment holes 302 may be used. In another example, rather than pairs of base attachment holes 302, base attachment holes 302 may include a single hole. Straps in the base of basket 124 may be threaded through and around the side of platform 122. Other attachment mechanisms, such as snaps, friction (e.g., non-skid grip material such as rubber on base 206 and/or on the underside of basket 124), an elevated frame that basket 124 can fit within, hook and loop (velcro) material all or part of the portions where base 206 meet basket 124, etc. may be used with equal success.

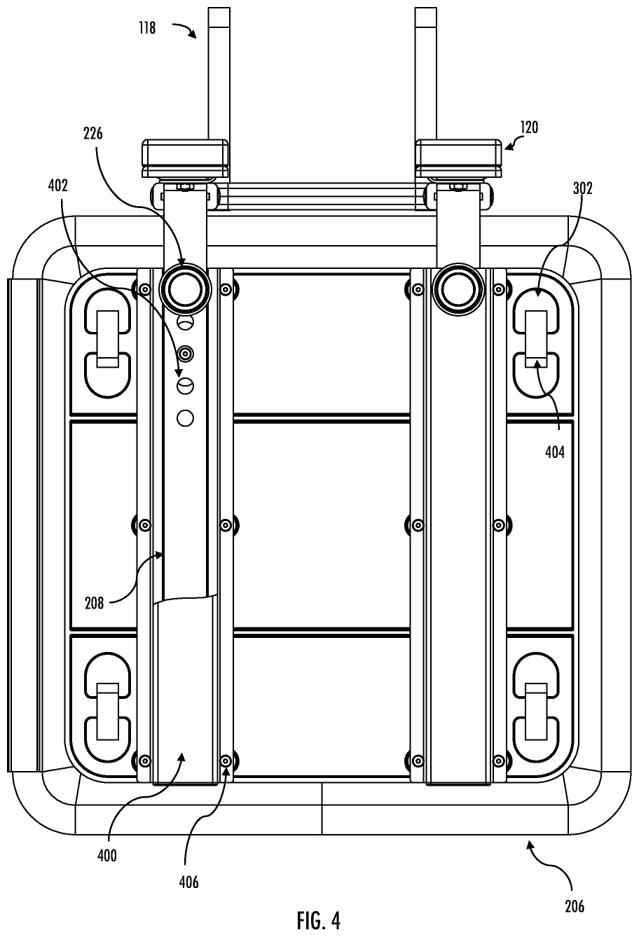

FIG. 4 illustrates an orthogonal view of an underside of base 206 of platform 122 with a cutaway portion of padding arm housing 400 to illustrate adjustable padding arms 208 and padding arm index holes 402.

Basket straps 404 are sewn into the underside (exterior base) of basket 124 and are threadable around a pair of base attachment holes 302. Basket straps 404 ensures basket 124 stays on platform 122 and does not shift laterally even when desk chair 102 moves with pet sidecar 100 attached. In one embodiment, basket straps 404 are hook and loop (velcro) straps, allowing for ease of installation and removal. In other embodiments, basket straps 404 may include ties (e.g., cable ties), straps (e.g., leather, nylon, or polypropylene webbing), or cables (e.g., coated steel).

Adjustable padding arms 208 are configured to allow padding plates 120 to adjust toward and away from base 206 of platform 122 so padding plates 120 may abut seat 104 of desk chair 102. Adjustment knobs 226 may lock adjustable padding arms 208 into one of a plurality of positions by fitting a pin inside adjustment knobs 226 within one of padding arm index holes 402 on adjustable padding arms 208. As illustrated, there are five padding arm index holes 402 on each of adjustable padding arms 208. In other examples, a greater or fewer number of index holes may be used with equal success.

Padding arm housing 400 is secured to base 206 using rivets 406. In other examples, other attachment mechanisms, including screws, welding, etc. may be substituted with equal success. Padding arm housing 400 may serve as a guardrail for adjustable padding arms 208. Adjustable padding arms 208 may slide on a track within padding arm housing 400 when in an unlocked position and is not slidable when in a locked position. Padding arm housing 400 includes an additional track (disposed between base 206 and adjustable padding arms 208) to fit a portion of an L-bracket that connects padding arm housing 400 (and base 206 of platform 122) to adjustment arm housing 214. In some examples, this additional track is a separate cover disposed between the L-bracket (affixed to base 206) and adjustable padding arms 208.

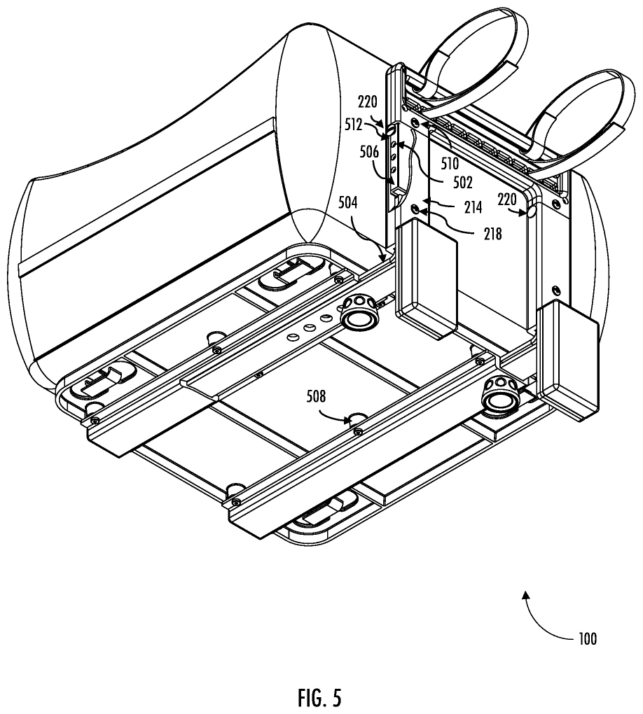

FIG. 5 illustrates a perspective view of pet sidecar 100 with a cutaway portion of padding arm housing 400 and adjustment arm housing 214. The cutaway of padding arm housing 400 reveals adjustable padding arms 208 and padding arm index holes 402 and the cutaway portion of adjustment arm housing 214 of adjustment arms 212 reveals adjustment arm index pin holes 502.

Attachment side support 210 includes an attachment (top) portion and two parallel adjustment arms 212 with adjustment arm housing 214. Each adjustment arm housing 214 of adjustment arms 212 provides a cover for L-bracket 504 and adjustment hub 506 with adjustment arm index pin holes 502 that accepts adjustment screws 220.

Adjustment arm housing 214 includes at least one pair of adjustment arm index pin holes 512 that accepts adjustment screws 220 when lined up with a set of the adjustment arm index pin holes 502 of adjustment hub 506. In some examples, adjustment arm housing 214 may provide structural support for platform 122. Adjustment arm housing 214 may be made of any suitable material that can provide the structural support for platform 122 and cover the internal components of adjustment arms 212. In one example, adjustment arm housing 214 includes a one or more rigid plastic or metal frame elements that may be connectable using screws (e.g., housing screws 218).

Adjustment hub 506 may include a hollow rectangular case with more than one pair of adjustment arm index pin holes 502. Adjustment hub 506 is coupled to an attachment portion of attachment side support 210 with screws 510. Adjustment hub 506 is adjustably coupled to adjustment arm housing 214 with adjustment screws 220. Adjustment hub 506 may be made of any suitable material that can provide the stability to support the weight of pet sidecar 100. In one example, adjustment hub 506 includes a rigid plastic or metal frame.

Adjustment screws 220 allow a user to select a height setting for attachment side support 210/adjustment arms 212 and lock adjustment arms 212 into the selected position. A user may remove the adjustment screw(s) 220 from the adjustment arm index pin holes 502 and 512 in adjustment hub(s) 506 and adjustment arm housing 214. The user may raise or lower adjustment arms to the selected height and (re-)insert adjustment screws 220 in adjustment arm index pin holes 502 and 512 in adjustment hub(s) 506 and adjustment arm housing 214. In some examples, a user may be able to adjust the height of each adjustment arms 212 independently. In other examples, the heights of adjustment arms 212 must be adjusted in tandem. In a locked setting adjustment screws 200 are inserted through both sets of adjustment arm index pin holes 512 and adjustment arm index pin holes 502 of adjustment hub 506. Adjustment screws 200 forms a connection between adjustment hub 506 (and the attachment portion of attachment side support 210) and adjustment arm housing 214 (as well as L-bracket 504 and the rest of platform 122).

Adjustment screws 220 may be low profile so a head portion (that extends outside of adjustment arm index pin holes 502 and 512) does not scratch desk chair 102. Adjustment screws 220 may also be fully removable (compared with, in some examples, adjustment knobs 226 on the underside of platform 122 as the likelihood of falling out of pet sidecar 100 is reduced.) Adjustment screws 220 maybe made of any suitable material that can secure adjustment arms 212 and provide the stability to support the weight of pet sidecar 100. In one example, adjustment screws 220 may include Chicago-screws that have a screw head on both ends. Alternatively, adjustment screws 220 may include a tee handle pin, a quick release pin, a hood pin, or any other suitable pin or screw. One or both sides of adjustment screws 220 may have a locking mechanism (e.g., one or more cross pin) to ensure adjustment screws 220 do not shift out of place.

L-bracket 504 is configured to attach attachment side support 210 and adjustment arms 212 to base 206. L-bracket 504 is disposed partially within adjustment arm housing 214 and connected to adjustment arm housing 214 via one or more housing screws 218. L-bracket 504 is secured to base 206 of platform 122 using screws, rivets, welding, or other suitable attachment mechanisms. L-bracket 504 may support the weight of base 206 of platform 122 and basket 124. In some examples, padding arm housing 400 serves as a guardrail on base 206 for L-bracket 504 to connect with.

Spacers 508 allows padding arm housing 400 to be at a height to accept L-bracket 504 and adjustable padding arms 208.

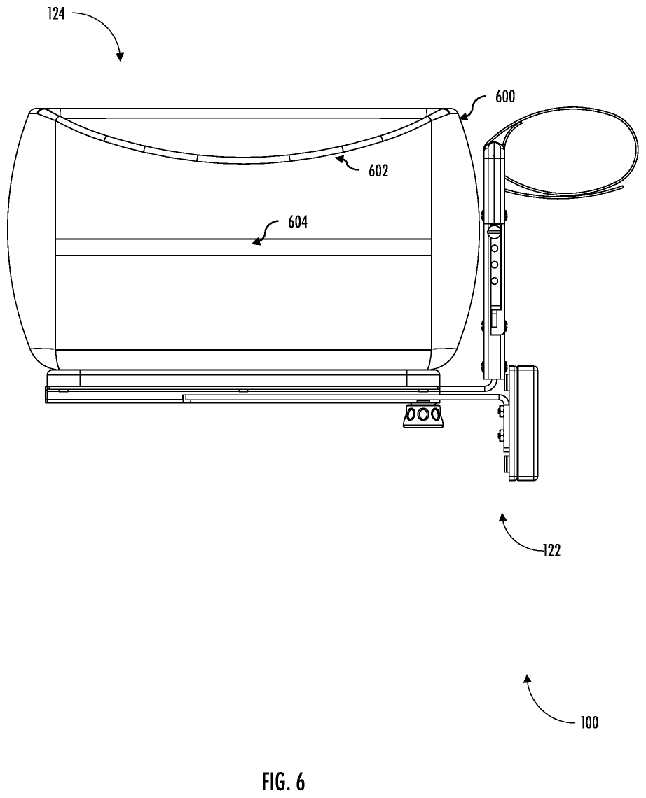

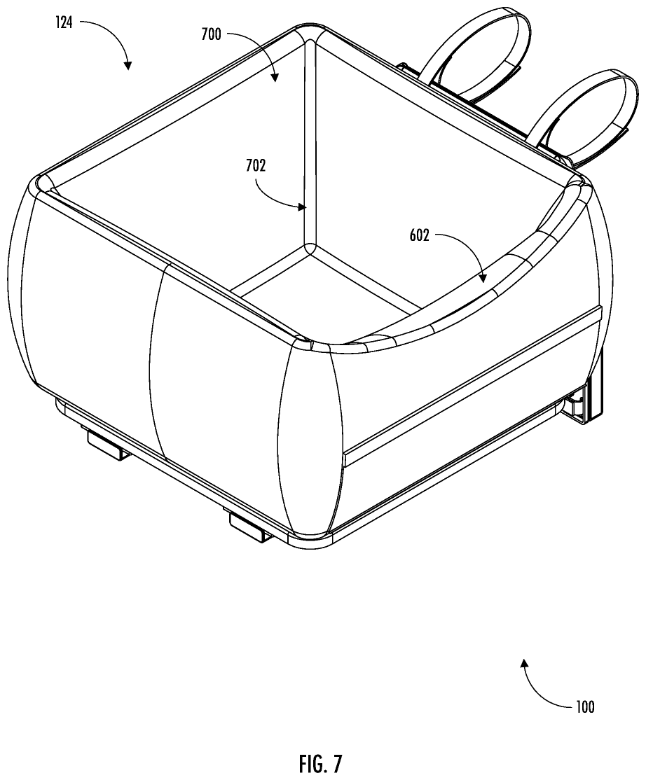

FIG. 6 illustrates an orthogonal front view of pet sidecar 100 (relative to the forward-facing side of desk chair 102 when pet sidecar 100 is attached to an arm side of desk chair 102) useful in illustrating aspects of the present disclosure. FIG. 7 is a perspective view of pet sidecar 100 illustrating an interior cavity 700 and interior structure 702 of basket 124.

Basket 124 is removably coupled to platform 122. This allows basket 124 and platform 122 to be separately cleanable. Basket 124 has a cleanable cover 600. In one example, cleanable cover 600 may include nylon, polyester, cotton, or other suitably washable or machine-washable material. As used herein, machine-washable material includes material able to be washed in a washing machine without damage. In other examples, cleanable cover 600 is made of chemical-free, organic, natural and/or anti-microbial materials. Cleanable cover 600 may be removed from basket 124 and replaced if soiled. Cleanable cover 600 may include padding and/or plush material for added comfort and safety for a seated pet.

In some examples, basket 124 is a cube or rectangular box shaped. Other suitable shaped baskets may be used with equal success, e.g., a semi-cylindrical or cylindrical basket, triangular basket, etc. On one or more sides, e.g., a forward-facing side, basket 124 has an arched cutaway 602 that allows a pet to comfortably stick their head over the top of basket 124.

Rigid tubes may form the outer framing of basket 124 to provide a structure that is covered by cleanable cover 600. The structure may include a basket frame. In one example, cleanable cover 600 fits over the basket frame forming basket 124 with a volume bounded on five sizes (leaving the top side open). The shape of the basket frame may be cubic, or a rectangular cubic frame, or some other shape formed from the rigid tubes. For example, the rectangular cubic frame comprises a plurality of tubes arranged as edges of a rectangular prism. In some examples, the rigid tubes may be surrounded with padding. In other examples, the rigid tubes are surrounded by padding on the interior sides of basket 124. The rigid tubed walls provide a structure that allows the pet to feel that it is in a stable structure that will not shift underneath them. Rigid tubes may be formed out of one or more of metal (e.g., aluminum or steel) and hard plastic (e.g., PVC). In other examples, basket 124 is formed from solid walled materials.

For use with smaller/lighter animals, basket 124 may be formed with a structured bottom with padded/plush edges or sidewalls. Basket 124 has walls at a sufficient height so the pet does not tip or fall out of basket 124. In some examples, walls are 14 inches high to ensure smaller pets are secure in basket 124 and do not tumble over the side walls of basket 124.

Basket 124 includes a pocket 604 that can hold snacks, toys, or accessories for the pet. Pocket 604 is disposed on the outside of basket 124. In some examples, pocket 604 is sewn into cleanable cover 600.

### Methods of Use

In addition to the pet sidecar 100 described above, one or more methods of installing a pet sidecar 100 to a desk chair 102 and use of pet sidecar 100 are contemplated. In one example, the method may include attaching pet sidecar 100 to desk chair 102. In one example, attaching pet sidecar 100 includes threading support straps 118 through apertures or adjustment holes 202 and 204 of attachment side support 210 and wrapping support straps 118 around an arm 106 of desk chair 102. Support straps 118 may be wrapped tightly so as to minimize the space between the desk chair 102 and pet sidecar 100.

The method may include adjusting the height of pet sidecar 100 (e.g., the length of attachment side support 210 in the direction from base 206 to the support straps 118). A user may insert or adjust the adjustment screws 220 in adjustment arm index pin holes 502 in adjustment hub 506 for a selected height. The height may be selected in order to align the padding plates 120 to the seat 104 of desk chair 102 to ensure base 206 of platform 122 is substantially parallel to the floor. Height selection may be performed following securing support straps 118 to aid in determining the needed height of pet sidecar 100/attachment side support 210.

The method may include adjusting the position of adjustable padding arms 208. Adjustable padding arms 208 may be adjusted by the user so padding plates 120 press upon (an arm-rest side of) seat 104 of desk chair 102. A user may adjust the location of padding plates 120 based on the position of seat 104. A user may remove/disengage a locking pin from padding arm index holes 402 in adjustable padding arms 208 to be in an unlocked state from a locked state. Once in the unlocked state, the user may slide/shift/pull/push adjustable padding arms 208 to the desired length and reinsert/re-engage the pin into a different index hole of padding arm index holes 402. The locked state may be characterized by the pin positioned within one of the padding arm index holes 402 disabling movement of one of the two sliding arms. Likewise, the unlocked state may be characterized by the index pin positioned outside padding arm index holes 402, allowing one or both adjustable padding arms 208 to slide freely.

In one example, spring loaded adjustment knobs, such as adjustment knobs 226, may adjust the state of adjustable padding arms 208. In this example, a user pulls on adjustment knob 226 unlocking adjustable padding arms 208. The user is then able to slide/shift adjustable padding arms 208. Once in the desired position, the user may release the adjustment knob 226 and it will spring back into the padding arm index holes 402 above adjustment knob 226 (or the closest hole). In some situations, a user may shift adjustable padding arms 208 to force the pin of adjustment knob 226 into padding arm index holes 402.

The method may include installing basket 124 onto the platform 122. The user may put cleanable cover boo onto interior structure 702 of basket 124. The user may then place basket 124 on platform 122 and thread basket straps 404 through base attachment holes 302 on base 206 of platform 122 and connect the straps together.

The method may include placing a pet inside the interior cavity 700 of basket 124. A user may then use the desk chair 102 as they would without pet sidecar 100 attached. For example, the user may roll desk chair 102 around their space, swivel desk chair 102, or raise or lower desk chair 102 with their pet inside the attached pet sidecar 100. Pet sidecar 100 maintains its position next to the seat of desk chair 102 during each of those maneuvers.

The pet sidecar apparatus and methods described herein are improvements over existing pet seat designs, particularly for use in the workplace, as the pet is seated at the same is at user height which improves the wellbeing of both pet and human as both pet and human can see each other and interact and one is not relegated to, e.g., a place on the floor or on a lower seat. The designs described in the present disclosure are adjustable to many types of chairs and configurations due to adjustable parts (e.g., the use of straps to accommodate different sized chair arms and padding plates that can be adjusted in multiple distinct directions/planes to meet the seat of the user's chair. Additionally, the apparatuses and methods of the present disclosure allow greater functionality of the user's space. For example, the user can fully use the desk chair and does not have to share the seat with or give up the desk chair to the pet. This allows for the desk chair to maintain mobility (pet sidecar 100 can move with the chair because, e.g., pet sidecar 100 does not have braces or supports to the ground to provide support). As a result, the apparatus does not need to be constantly reinstalled as the user changes the chair's configuration or position. Further, the disclosed apparatus can easily be disassembled (e.g., separatable basket, pads, covers, etc.) and cleaned in anticipation of inevitable messes.

### Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A pet sidecar apparatus comprising:
a basket, comprising:
a rectangular cubic frame;
a cover removably coupled to the rectangular cubic frame;
a basket strap sewn into the basket; and
a platform, comprising:
a base having a plurality of basket holes to connect to the basket strap;
a sliding arm having a first plurality of index holes and coupled to the base;
an adjustment knob comprising an index pin and coupled to the sliding arm;
a padding plate connected to the sliding arms configured to slide outward with the sliding arm;
an L-bracket;
a sliding arm housing coupled to the sliding arm and the L-bracket;
an attachment side support comprising an attachment portion and an adjustment arms, the adjustment arm comprising a sliding arm housing coupled to the L-bracket;
an adjustment hub having a second plurality of index holes, the adjustment hub coupled to the attachment portion of the attachment side support and removably coupled to the sliding arm housing;
an adjustment screw removably coupled to the adjustment hub; and
a support strap coupled to the attachment portion of the attachment side support.

2. The pet sidecar apparatus of claim 1, where the padding plate comprises padding coupled to a metal backer plate and the padding plate is removably coupled to the sliding arm via a padding strap.

3. The pet sidecar apparatus of claim 1, where:
the support strap of the pet sidecar apparatus are configured to wrap around an arm of a chair;
the two padding plates are configured to brace the pet sidecar apparatus against a seat of the chair, and
a position of the padding plate is adjustable by sliding the sliding arm and adjusting the adjustment screw in one of the second plurality of index holes.

4. The pet sidecar apparatus of claim 1, where:
the base of the platform is characterized by an underside, and
the two sliding arms are coupled to the underside of the base of the platform.

5. The pet sidecar apparatus of claim 1, where:
the adjustment knob may in a locked state and an unlocked state,
the locked state characterized by the index pin positioned within the first plurality of index holes disabling movement of the sliding arm, and
the unlocked state characterized by the index pin positioned outside the first plurality of index holes, allowing the sliding arm to slide freely.

6. A pet seat apparatus attachable to a chair, comprising:
a basket;
a platform configured to support the basket, the platform having one or more apertures; and
one or more straps configured to be threaded through the one or more apertures of the platform to attach the pet seat apparatus to the chair.

7. The pet seat apparatus of claim 6, wherein the basket is removably connected to the platform.

8. The pet seat apparatus of claim 6, where the basket comprises a plurality of tubes arranged as edges of a rectangular prism.

9. The pet seat apparatus of claim 8, where a removable cover is fit over the plurality of tubes forming the basket with a volume bounded on five sides.

10. The pet seat apparatus of claim 6, wherein the platform comprises one or more pads, a position of the one or more pads adjustable to abut a seat of the chair.

11. The pet seat apparatus of claim 10, where:
the platform comprises one or more extendable arms coupled to the pads, and
the position of the one or more pads is adjustable by adjusting a height of the platform and extending the extendable arms.

12. The pet seat apparatus of claim 6, where the one or more straps are configured to secure the pet seat apparatus to an armrest of the chair.

13. The pet seat apparatus of claim 6, where all weight of the pet seat apparatus is applied to the chair via the one or more straps.

14. The pet seat apparatus of claim 6, where the pet seat apparatus is configured to mount to an arm-side of the chair.

15. The pet seat apparatus of claim 6, where the platform is at seat height when attached to the chair.

16. The pet seat apparatus of claim 6, where a combined center of gravity of the pet seat apparatus and the chair is within an area above a floor bounded by a base of the chair.

17. The pet apparatus of claim 6, where:
the chair comprises casters configured to enable the chair to roll, and
when the pet apparatus is to the chair, the casters continue to enable the chair to roll.

18. The pet apparatus of claim 6, where the basket comprises a machine-washable removable cover.

19. A method of installing a pet seat to a chair, comprising:
wrapping support straps of a platform of the pet seat around an armrest of the chair;
adjusting a height of the platform of the pet seat based on a position of a seat of the chair;
adjusting a location of a padding plate based on the position of the seat; and
installing a basket on the platform of the pet seat.

20. The method of claim 19, wherein adjusting the location of the padding plate based on the position of the seat comprises:
disengaging a locking pin from a first index hole in an adjustable arm coupled to the padding plate;
sliding the adjustable arm such that the padding plate presses against the seat of the chair; and
re-engaging the locking pin in a second index hole in the adjustable arm.
